(19) United States
(12) Patent Application Publication
(10) Pub. No.: US 2004/0197550 A1
(43) Pub. Date: Oct. 7, 2004

(54) Structure and fabricating method of optic protection film

(75) Inventors: Shun-Hsiang Ke, TaoYuan (TW); Ta-Wang Lai, TaoYuan (TW); Bor-Ping Wang, TaoYuan (TW); Chyi-Hung Lin, TaoYuan (TW); Feng-Yu Huang, TaoYuan (TW); Hsiu-Min Feng, TaoYuan (TW)

Correspondence Address: BRUCE H. TROXELL, SUITE 1404, 5205 LEESBURG PIKE, FALLS CHURCH, VA, 22041, US

(73) Assignee: Optimax Technology Corporation

(21) Appl. No.: 10/624,518

(22) Filed: Jul. 23, 2003

(30) Foreign Application Priority Data
Apr. 1, 2003 (TW) 92107336

(51) Int. Cl. B05D 5/06

(52) U.S. Cl. 428/327; 427/162

(57) ABSTRACT

The present invention discloses a structure and a fabricating method of optic protection film. The structure is a conductive thin film structure that comprise two kinds of different resins, a resin A and a resin B, formed on a plastic substrate respectively to attain the functions of anti-static and anti-glare. Wherein, there are two kinds of conductive particles with different grain size in resin A, and the grain size of the conductive particles with bigger grain size is among the total thickness of the two resin film; moreover, in the conductive particles with bigger grain size, at least the upper rims of the partial conductive particles with bigger grain can touch to or expose in the exterior of the upper surface of the resin B so as to provide the functions of conductivity and anti-static. The materials of the resin B are selected so that the materials are harder after being solidified to provide the effect of the hard coating layer without adding extra conductive particles. Besides, some silica tiny particles can be added into the neighborhood of the uppermost surface of the resin B film to provide the function of anti-glare.

### FIELD OF THE INVENTION

The invention relates to a structure and fabricating method of optic protection film that provides anti-static and anti-glare function. In particular, the invention relates to a plastic substrate structure comprising conductive particles and tiny particles in different size so as to achieve the foregoing functions.

### BACKGROUND OF THE INVENTION

Glass substrate or transparent plastic substrate is one of the essential elements in flat display, and wherein the transparent plastic substrate surpasses the glass substrate in lighter weight and uneasy blowout etc. But the plastic substrate still has its weakness, such as adsorbing the dust easily because of static electricity. To take liquid crystal display as an example, traditional Simple Matrix liquid crystal display (SM-LCD), whose structure is shown in FIG. 1, comprises (from top to bottom) a hard coating layer 13, a conductive layer 12, a protection film 11, a polaroid 10, a glass substrate 30, a row electrode 50, a liquid crystal layer 80, a column electrode 60, a dichroic filter 70, a g lass substrate 40, a polarizing filter 20, a protection film 21, a conductive layer 22, a hard coating layer 23. FIG. 1 shows that the liquid crystal molecule is located between the row electrode 50 and the column electrode 60 and is driven to turn by the exteriorly provided driving voltage. But some problems may be occurred in SM-LCD such as (1) cross-talk accomplished with the increase of scan electron (2) charges accumulation, electro field interference, and liquid crystal operating issue that happens in the top and bottom polaroids. So in the manufacturing process of polaroid, protection film and release film will be pasted in both top and bottom sides respectively. The function of the protection film is to protect the film surface of the polarizing filter, avoiding damage in the manufacturing or delivering. And the release film is used to carry on the sticking protection before panels are plastered. When the protection film is being torn, the film surface will accumulate static electricity because of rub, and then the remained static electricity will attract the foreign body; on the other hand, when release film is being torn in manufacturing process, it will also produce the static electricity accumulation, which will not only attract the foreign body but also result in deviation in the matching process of panel plastering, which effects the process yield. Therefore, the anti-static anti-glare film (ASAG film) is designed to solve these issues. The ASAG film on the whole contains three layer constructions as described previously, which are a hard coating layer 13, a conductive layer 12, and a protection film 11.

In the anti-static technology, sputtering method also can be used to form conductive layers. It can produce more uniform grain size particles, better adhesion with substrate, and better optic character. But because the process needs to proceed in a vacuum camber, there are still disadvantages that the equipment cost is very high and that the film of raw material is not easy to operate in such a vacuum chamber. There is another way to form the conductive layer that uses the wet coating method, which is a two-layer coating method enclosed by Dai Nippon Printing Co., as shown in U.S. Pat. No. 6,146,753, forming a transparent conductive layer and a hard coating layer successively on the transparent protection film (abbreviated as “plastic substrate” hereafter). Wherein the conductive layer contains conductive particles of antimony TiN oxide (ATO) or indium TiN oxide (ITO); its surface impedance is ≦10⁸ Ω/□ and can reduce the electrostatic generation. The increased conductive layer can reduce the surface impedance to 10⁶ Ω/□˜10⁷ Ω/□ or so, so as to prevent a great deal of static electricity creation. Because the consideration of the transmittance, generally the thickness is about 5 μm. The conductive layer is not hard enough, easily falling off when colliding, so it needs to coat a hardened resin to strengthen. Moreover, because the hardened resin has no electric conductivity, it needs to add conductive particles to extend the conductivity and remove the accumulation charges. However the conductive metal particles are very expensive, which greatly raises the coating cost and the difficulty of manufacturing.

The hard coating layer is coated with the mixture of hardened resin and conductive metal particles; the hardened resin provides the basic requirement of hardness, and the conductive metal particles provide the electric conductivity between the coated surface and the conductive layer. If the thin film wants to increase the anti-glare function, the hard coating layer can be added with nano-level tiny particles, which can scatter the incident light to provide the anti-glare function.

The present invention is to aim at the necessary of the plastic substrate to provide an optic protection film with anti-static and anti-glare function, solving the foregoing fabrication issues.

### SUMMARY OF THE INVENTION

The major objective of the present invention is to provide a fabrication method of an optic protection film, which is to add some conductive particles to attain the anti-static function when forming the conductive layer onto the plastic substrate.

Another objective of the present invention is to provide a fabrication method of an optic protection film, which is to add some tiny particles so as to attain the function anti-glare when forming the conductive layer onto the plastic substrate.

The other objective of the present invention is to provide a structure of an optic protection film, which has better hardness and better adhesion with plastic substrate.

First, a plastic substrate, the material of which is Cellulose Triacetate or polyester, is selected, and then a conductive layer is formed on the plastic substrate. The conductive layer is a double-layer resin film structure made of two kinds of different resins. In the beginning, some conductive particles, which have two different grain sizes, are melted into resin A to enhance the conductive effect of resin A. The resin A that contained conductive particles is coated on the substrate by wet coating method. Then the most alcohol in resin A is evaporated in the hot bake step so as to fasten the resin A; the thickness of resin A is less than the bigger grain size conductive particles in resin A after hot bake. And then polymer in resin A can process polymerization to strengthen the structure by thermosetting or ultraviolet light curing method. Next, some smaller SiO2 particles are added into resin B that has better hardness to attain the anti-glare function. The resin B contained tiny particles is coated on the resin A and fills all the gaps between the conductive particles. Then resin B is strengthened in the hot bake and thermosetting or ultraviolet curing step. At this time, because the grain size of the conductive particles is larger, at least the upper rims of the partial bigger conductive particles can touch to or expose in the exterior of the upper surface of resin B so as to prevent charges accumulating in resin B and to attain the anti-static effect. Thus, the optic protection film with anti-static and anti-glare function is accomplished.

### BRIEF DESCRIPTION OF THE DRAWINGS

FIG. 1 is a sectional view of the traditional SM-LCD.

FIG. 2A is a sectional view of the plastic substrate according to the embodiment of the present invention.

FIG. 2B is a sectional view of the conductive particles according to the embodiment of the present invention.

FIG. 2C is a sectional view of the conductive layer with anti-glare function according to the embodiment of the present invention.

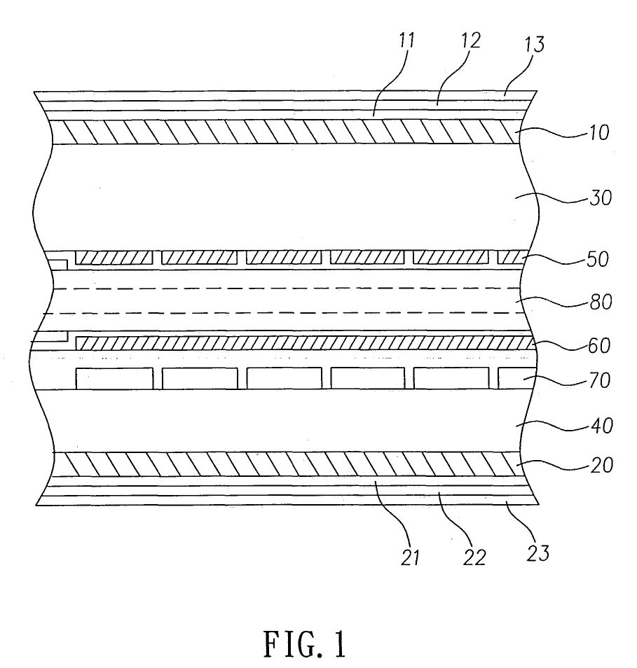

### DETAILED DESCRIPTION OF THE INVENTION

The present invention mainly is to provide the function of electricity conductivity and anti-static by adding at least two kinds of different size conductive particles, that is, some bigger conductive particles and some smaller conductive particles, into resin A that comprises the conductive layer. Wherein, the thickness of solidified resin A is larger than the grain size of the conductive particles of smaller grain size, however less than that of the conductive particles of bigger grain size. Resin B is composed of the relatively high hardness material, coated on resin A to be a hard coating layer. Moreover, in the foregoing conductive particles of bigger grain size, at least the upper rims of partial bigger conductive particles can touch to or expose in the exterior of the upper surface of resin B, contacting the external environment. So resin B need not to add extra conductive metal particles anymore, but the charges of resin A can be released to the exterior, avoiding accumulating in resin B; such can attain the anti-static function, simplify the fabrication process, and reduce the cost.

To elaborate the key points of the present invention, the present invention will take the protection film of flat panel fabrication as an embodiment matched with corresponding drawings.

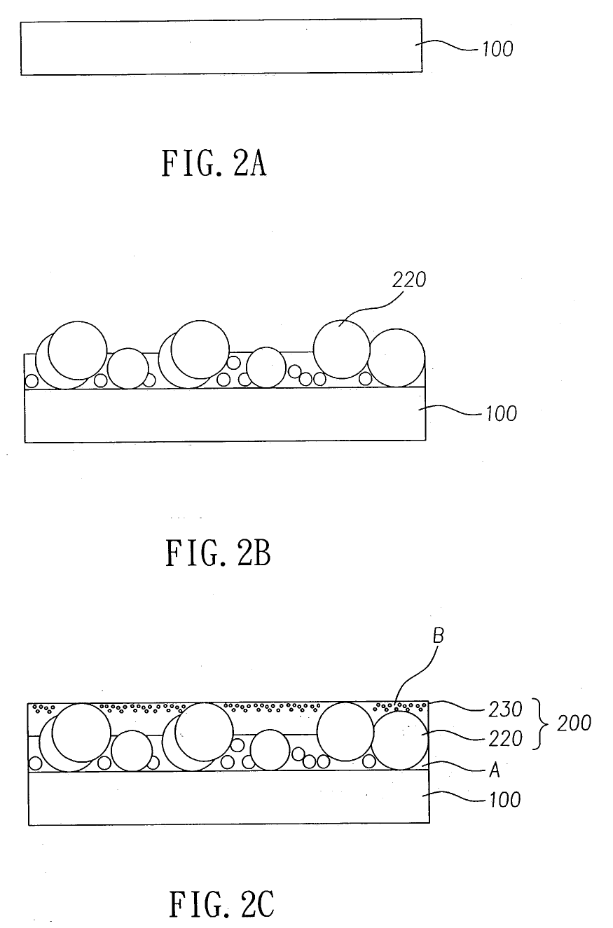

First, shown in FIG. 2A is a plastic substrate 100, the material of which can be cellulose, diacetate, triacetate, cellulose acetate butyrate, polyester, polyamide, polyimide, polyether sulfone, polysulfone, polypropylene, polymethylpentene, polyvinyl chloride, polyvinyl acetal, polyether ketone, methyl polymethacrylate, polymethymethacrylate (PMMA), polycarbonate, and polyurethane. Wherein, the better material is cellulose triacetate (TAC) and Poly-Ethylene (PET). The mentioned TAC or PET is a familiar substrate material in commerce, for example Fuji and Konica etc. all provide such kinds of substrate.

Next is going to start the key point of the present invention to form a conductive layer 200 on plastic substrate 100. The conductive layer 200 is a double-layer structure including: a thin film layer of resin A contained conductive particles to provide better conductivity, and a thin film layer of resin B that is relatively harder and can be a hard coat layer. The formation of this conductive layer 200 can be divided into two steps: depositing or coating conductive particles 200 and resin A on substrate 100, then forming tiny particles 230 and resin B onto the foregoing. The detail embodiment steps are described below. As shown in FIG. 2B, firstly, the conductive particles 220 are mixed into resin A, which is mainly composed of 1-Butanol, Ethanol, Ethyl acetate (EAC), Hexane, isopropanol (IPA) 80%, and partial acrylic resin; the solid content of resin A is 5˜25%. The weight percentage of conductive particles 200 to resin A is among 5˜30%, and the conductive particles 200 have two sizes: the bigger grain size (the diameter is about 0.5˜7 μm) and the smaller grain size (the diameter is about 0.1˜0.5 μm). Wherein the conductive particles of bigger grain size account for 0.5˜10% in the conductive particles 200 and the conductive particles of smaller grain size account for 90˜99.5%. The conductive particles 200 can be composed of antimony tin oxide (ATO) or indium-tin oxide (ITO). The resin A that contains at least two kinds conductive particles 220 of different grain size is coated on the substrate 100 to form a 5 μm thin film by wet coating method; wherein the method of wet coating can be spin coating, roll coating, gravure coating, bar coating, and slot die coating etc. As shown in FIG. 2B, the resin A of the embodiment in the present invention will become thinner after the solidification steps of hot bake and ultraviolet light curing, and thus will not cover all the conductive particles. Relatively, the thickness of resin A after the solidification processing is merely larger than the conductive particles of smaller grain size but less than the conductive particles of bigger grain size, making all the bigger grain size conductive particles protruding at least some portions to the exterior of the upper surface of the solidified resin A layer (as shown in FIG. 2B). The conductive particles 220 composed of ATO (or ITO) are used to be the conductive elements of conductive layer in the traditional structure. In addition to adding ATO (or ITO) particles of the original grain size (about 0.1˜0.5 μm), like traditional fabrication process, the present invention even adds some extra ATO (or ITO) particles of bigger grain size (about 0.5˜7 μm). Under the premise keeping the original conductivity, the present invention uses the ATO particles of bigger grain size to fill and bridge vertically between resin A and resin B, making the resin B still have the anti-static function without adding any conductive particles. This method can prevent the drawback in the prior art that extra conductive metal particles need to be added into hard coating layer to avoid the charge accumulation, and can reduce the difficulty of fabrication process and cost.

Further, the thermal curing of solidification is processing, which is to evaporate the most portion of alcohol in resin A in the hot bake step so as to fasten resin A. The temperature of hot bake is among 50˜95° C., and the hot bake time is about 0.5˜5 min. The temperature of the hot bake depends on what kinds of solvent is used in resin A, and needs to be lower than the boiling point of the solvent. In this embodiment, the solvent can be isopropanol, so the temperature of hot bake is about 60° C. Next, ultraviolet light is used to make the polymer in resin A proceed polymerization of cross-link to strengthen the structure; wherein, the intensity of ultraviolet light is among 150˜1000 mJ/cm², and the thickness of the resin A after solidified is about 0.5˜2 μm.

Further, 1˜3 wt % silicon oxide (silica) tiny particles 230, in nano level, are added into resin B and stirred by homogenizer; the grain size of silica tiny particles 230 is among 0.1˜1.0 μm. The solid content of resin B is 45˜50%, and its major content is acrylic resin; after the solidification process, resin B can get better hardness and thus be used as a hard coating layer. The silica tiny particles 230 will cluster upward in the process of solidification and of resin B coating because of their buoyancy. So when incident light is entering, the tiny particles, which are in the surface of the most outer layer (resin B layer), can scatter the incident light to irregular directions and attain the anti-glare effect. The resin B contained tiny particles 230 is formed onto resin A by wet coating method, and fill all the gaps between conductive particles 220 to perform an about 10 μm thin film; the tiny particles 230 will float in the surface neighborhood of resin B because of their buoyancy to exert the anti-glare function. Wherein, the wet coating method can be the same as or different to the coating method of resin A. Next step is solidification, which evaporates the most solvent in resin B to fasten resin B by hot bake method; the temperature of hot bake is among 50-95° C. and the process time is 0.5˜5 min. Then ultraviolet light is used to make the polymer in resin B proceed polymerization of cross-link so as to strengthen the structure; wherein, the intensity of ultraviolet light is among 150˜1000 mJ/cm², and the thickness of resin B after solidified is about 4˜5 μm.

Thus the conductive layer 200 of such formation will has the function of hard coating protection, anti-static, and anti-glare etc., and the conductive particles 220 make conductive layer 200, whether resin A film or resin B film, possess the static electricity removing function. The hardness of resin B is high enough to protect conductive layer 200 and substrate 100, and can provide the effect of hard coating layer in tradition fabrication. Moreover, The present invention can be applied to the surface optic film of flat panel displays (such as LCD, PDA, PDP, NOTE-PC, CRT etc.). The anti-glare and anti-static functions of this optic film can satisfy the requirement of LCD panel manufacturers who demand the anti-static raw material, and can reduce the dust absorbing in flat panel displays to increase the comfort of users.

In summary, the present invention is to add at least two kinds conductive particles of different grain size into resin A. Wherein the grain size of the bigger conductive particles is not only larger than the thickness of resin A after solidified but even also equal to or larger than the total thickness of resin A and resin B after solidified. At least the upper rims of partial bigger conductive particles can touch to or expose in the exterior of the upper surface of resin B, contacting the external environment. So the resin B used to be a hard coating layer will not need to add conductive metal particles, but still can remove the charges in resin A film to the external environment, avoiding charge accumulating in resin B and attaining the anti-static function. Therefore, compared with the prior arts (such as U.S. Pat. No. 6,146,753), which need to add conductive particles in hard coating layer and thus result in the increasing of cost and the difficulty of fabrication, the present invention can simplify the fabrication process and reduce the cost.

However, the above description is only the preferable embodiment of the invention and cannot be used as a limitation for the scope of implementation of the invention. Any variation and modification made from the scopes claimed from the invention all should be included within the scope of the present invention, and hope your esteemed reviewing committee member examine this application favorably and permit it as a patent wishfully.

What is claimed is:

1. A fabricating method of an optic protection film, which comprising the steps of:
(a) preparing a substrate, a resin A, and a resin B, wherein the resin A comprising at least two different conductive particles in grain size, one conductive particle is with bigger grain size and another conductive particle is with smaller grain size;
(b) coating the resin A onto the substrate and proceeding solidification to form a thin film on the resin A, wherein the thickness of the resin A is less than the grain size of the conductive particles with bigger grain size, but greater than the grain size of the conductive particles with smaller grain size; and
(c) coating the resin B onto the resin A film and proceeding solidification to form a thin film on the resin B, wherein at least upper rims of partial bigger conductive particles of the conductive particles with bigger grain size are able to touch to or expose in the exterior of the upper surface of the resin B to contact external environment.

2. The fabricating method of the optic protection film according to claim 1, wherein the grain size of the conductive particles with bigger grain size described in step (a) is 0.5˜7 μm, and the grain size of the conductive particles with smaller grain size is 0.1˜0.5 μm.

3. The fabricating method of the optic protection film according to claim 1, wherein the conductive particles are composed of one of antimony tin oxide (ATO) and indium-tin oxide (ITO) alternatively.

4. The fabricating method of the optic protection film according to claim 1, wherein the substrate is composed of one of cellulose triacetate (TAC) and Poly-Ethylene (PET) alternatively.

5. The fabricating method of the optic protection film according to claim 1, wherein the resin A is composed of one of 1-Butanol, isopropanol (IPA), and acrylic resin.

6. The fabricating method of the optic protection film according to claim 5, wherein the solid content of the resin A is 5˜25%.

7. The fabricating method of the optic protection film according to claim 1, wherein the solidification process described in the step (b) and the step (c) include a hot bake step to evaporate the solvent of the resin, the operating temperature of the hot bake step is among 50˜95° C. and the hot bake time is among 0.5˜5 min.

8. The fabricating method of the optic protection film according to claim 1, wherein the solidification process described in the step (b) and the step (c) also include a step of resin polymerization of cross-link by ultraviolet light, and wherein the intensity of ultraviolet light is among 150˜1000 mJ/cm²

9. The fabricating method of the optic protection film according to claim 1, wherein the resin B is composed of acrylic resin.

10. The fabricating method of the optic protection film according to claim 1, wherein the resin B includes tiny particles.

11. The fabricating method of the optic protection film according to claim 10, wherein the tiny particles is silicon oxide (silica).

12. The fabricating method of the optic protection film according to claim 10, wherein the solid content of the resin B is 45˜50%.

13. The fabricating method of the optic protection film according to claim 10, wherein the grain size of the tiny particles is among 0.1˜1.0 μm.

14. A structure of a optic protection film comprises:
a substrate;
a resin A film, formed on the substrate, includes a plurality of conductive particles with bigger grain size and a plurality of conductive particles with smaller grain size, the thickness of the resin A film is between the grain size of the conductive particles with bigger grain size and that of the conductive particles with smaller grain size; and
a resin B film, formed on the resin A film, and at least the upper rims of partial conductive particles with bigger grain are able to touch to or expose in the exterior of the upper surface of the resin B to contact external environment.

15. The structure of the optic protection film according to claim 14, wherein the substrate is composed of one of cellulose triacetate (TAC) and Poly-Ethylene (PET) alternatively.

16. The structure of the optic protection film according to claim 14, wherein the wherein the grain size of the conductive particles with bigger grain size is 0.5˜7 μm, and the grain size of the conductive particles with smaller grain size is about 0.5 μm.

17. The structure of the optic protection film according to claim 14, wherein the conductive particles are composed of one of antimony tin oxide (ATO) and indium-tin oxide (ITO) alternatively.

18. The structure of the optic protection film according to claim 14, wherein the resin B includes a plurality of tiny particles, and the tiny particles are distributed in the neighborhood of the upper surface of the resin B film.

19. The structure of the optic protection film according to claim 14, wherein the tiny particles are silicon oxide (silica), and the grain size of the tiny particles is among 0.1˜1.0 μm.

20. A structure of a optic protection film comprises:
a substrate;
a resin A film formed on the substrate;
a resin B film formed on the resin A film;
a plurality of conductive particles with smaller grain size, wherein the grain size of the conductive particle is less than the thickness of the resin A film, and the conductive particles with smaller grain size are distributed only in the resin A film; and
a plurality of conductive particles with bigger grain size, wherein the grain size of the conductive particle is bigger than the thickness of the resin A film, the conductive particles with bigger grain size are distributed in the range of the resin A film and resin B film, and at least the upper rims of partial conductive particles with bigger grain are able to touch to or expose in the exterior of the upper surface of the resin B to contact external environment.

21. The structure of the optic protection film according to claim 20, wherein the resin B film includes tiny particles comprised of silica, and the tiny particles are distributed in the neighborhood of the upper surface of the resin B film.
